(19) United States
(12) Patent Application Publication
(10) Pub. No.: US 2026/0299266 A1
(43) Pub. Date: Oct. 1, 2026

(54) OPTICAL SYSTEM AND IMAGE PICKUP APPARATUS

(71) Applicant: CANON KABUSHIKI KAISHA, Tokyo (JP)

(72) Inventors: Hayato KATO, Tochigi (JP); Toyokatsu FUJISAKI, Tochigi (JP)

(21) Appl. No.: 19/574,511

(22) Filed: Mar. 23, 2026

(30) Foreign Application Priority Data
Mar. 26, 2025 (JP) 2025-051313

(51) Int. Cl. G02B 13/02; G02B 1/04; G02B 9/64; G02B 13/00; H04N 23/55

(52) U.S. Cl. CPC G02B 13/02; G02B 1/041; G02B 9/64; G02B 13/0045; G02B 13/0055; H04N 23/55

(57) ABSTRACT

An optical system may include, in order from an object side to an image side, a first lens unit, an aperture stop, and a second lens unit. The first lens unit may include a lens A, which is closest to the object side and has a negative refractive power. The second lens unit may include a lens B having negative refractive power.

### BACKGROUND

### Field of the Technology

The present disclosure relates to an optical system suitable for imaging (shooting or capturing an image), and an image pickup apparatus.

### Description of the Related Art

In a case where the refractive power of each lens unit is increased in order to reduce the size of the optical system, it becomes difficult to correct various aberrations, particularly chromatic aberrations such as longitudinal and lateral chromatic aberrations.

Japanese Patent Application Laid-Open No. 2022-23759 discloses a small, lightweight, and wide-angle lens that uses aspherical lenses to correct various aberrations such as curvature of field.

### SUMMARY

An optical system according to one aspect of the present disclosure may include, in order from an object side to an image side, a first lens unit, an aperture stop, and a second lens unit. The first lens unit may include a lens A, which is closest to the object side and has a negative refractive power. The second lens unit may include a lens B having negative refractive power. The following inequalities may be satisfied:

$$1.7 \leq Ndn 2 \leq 2 \text{.00}$$

$$8. \leq vdn 2 \leq 22. .$$

$$0.8 \leq SL / f \leq 3.$$

where Ndn2 is a refractive index of the lens B at d-line, vdn2 is an Abbe number of the lens B based on the d-line, f is a focal length of the optical system, and SL is an air-equivalent distance on an optical axis from the aperture stop to an image plane. An image pickup apparatus including the above optical system also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view of an optical system according to Example 1 in an in-focus state at infinity.

FIG. 2 is a longitudinal aberration diagram of the optical system according to Example 1.

FIG. 3 is a sectional view of an optical system according to Example 2 in an in-focus state at infinity.

FIG. 4 is a longitudinal aberration diagram of the optical system according to Example 2.

FIG. 5 is a sectional view of an optical system according to Example 3 in an in-focus state at infinity.

FIG. 6 is a longitudinal aberration diagram of the optical system according to Example 3.

FIG. 7 is a sectional view of an optical system according to Example 4 in an in-focus state at infinity.

FIG. 8 is a longitudinal aberration diagram of the optical system according to Example 4.

FIG. 9 is a schematic diagram of an image pickup apparatus having any one of the optical systems according to Examples 1 to 4.

### DESCRIPTION OF THE EMBODIMENTS

Referring now to the accompanying drawings, a description will be given of examples according to the present disclosure.

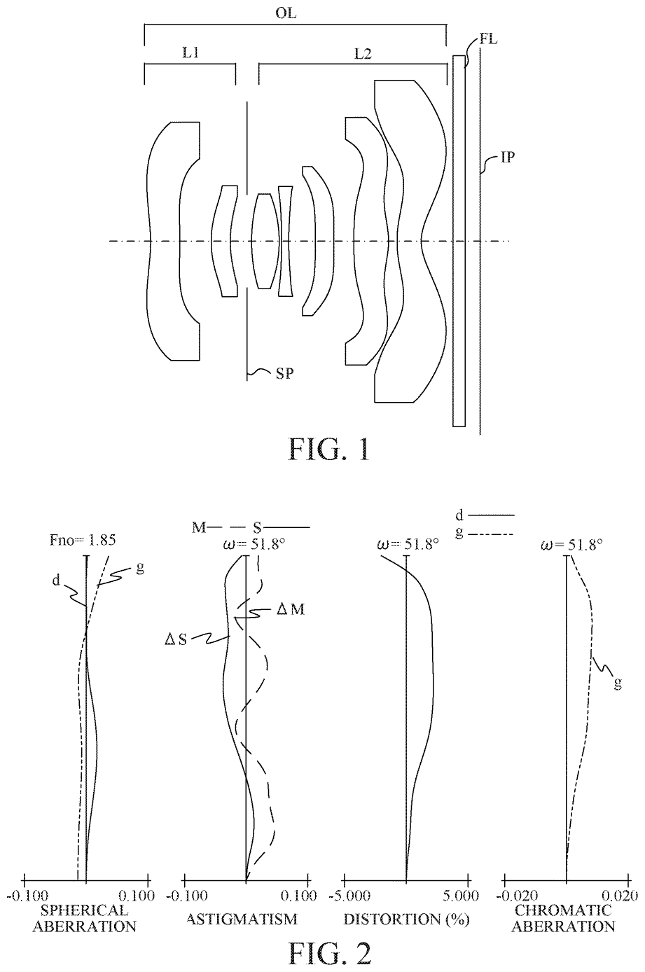

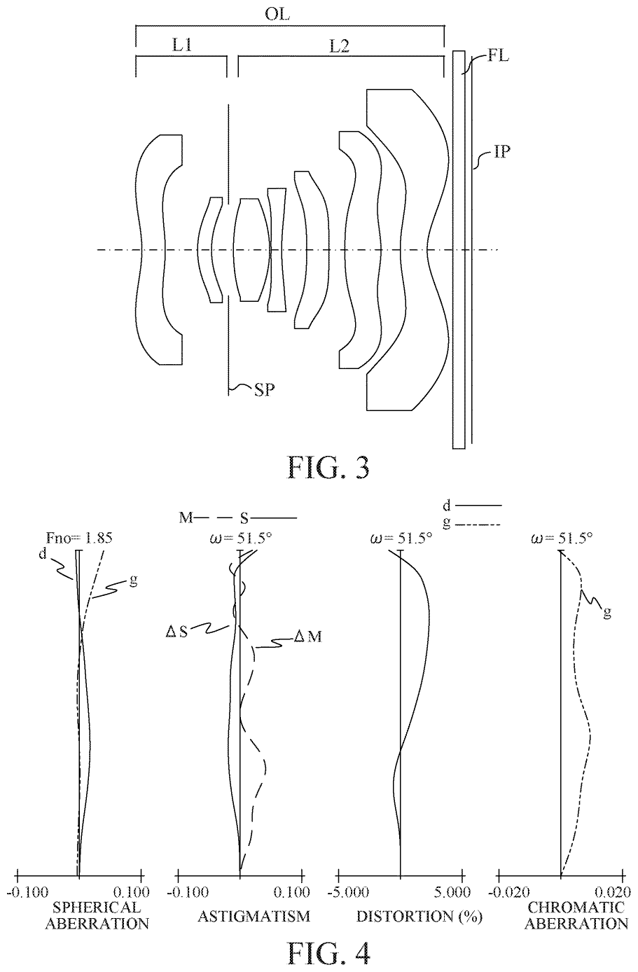

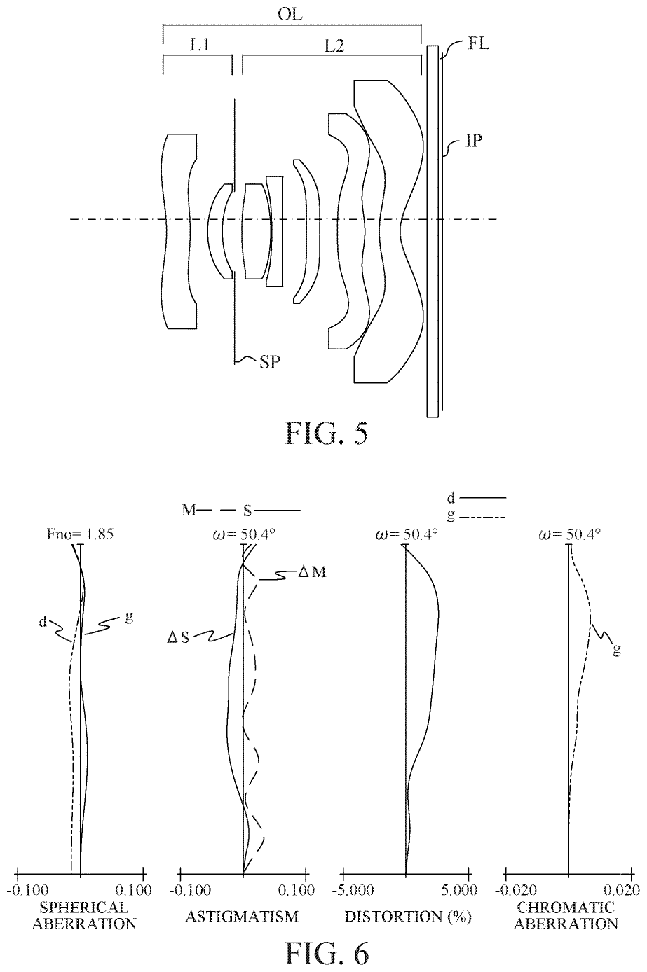

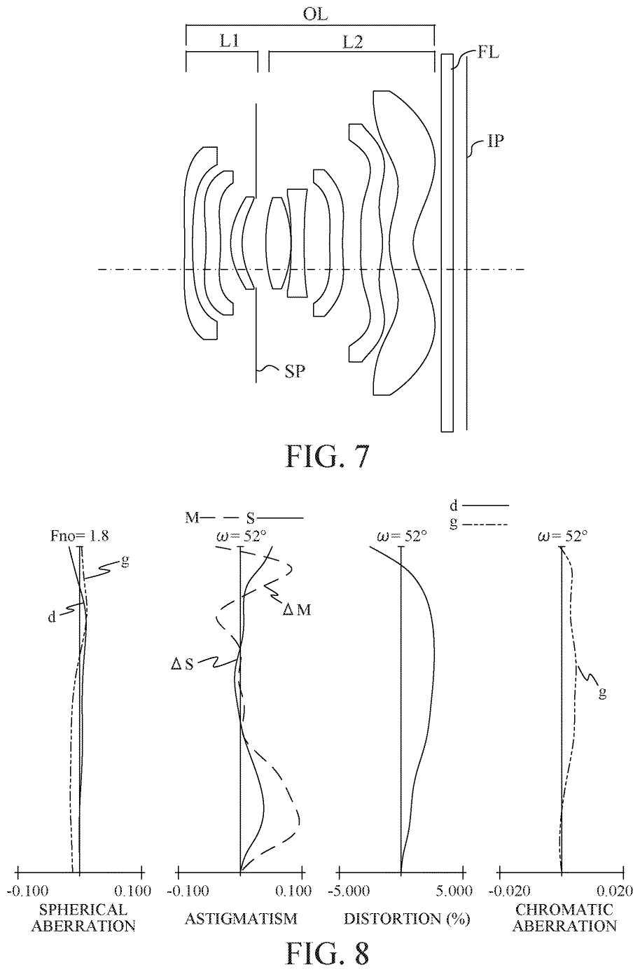

FIGS. 1, 3, 5, and 7 illustrate cross-sections of optical systems according to Examples 1 to 4 in an in-focus state at infinity, respectively. In each figure, the left side is the object side (front side), and the right side is the image side (back side). The optical systems according to each example are suitable for a variety of image pickup apparatuses such as video cameras, digital still cameras, smartphone cameras, surveillance cameras, on-board (in-vehicle) cameras, and film-based cameras.

The optical system OL according to each example includes (consists of), in order from the object side to the image side, a first lens unit L1, an aperture stop SP, and a second lens unit L2. Each lens unit consists of one or more lenses. Each lens unit may include an aspherical lens that has no refractive power on the optical axis, that is, with infinite curvature on the optical axis. The aperture stop SP determines (limits) a light beam of the maximum aperture.

The optical system OL may perform focusing by moving all or part of the system in the optical axis direction. FL represents an optical block such as a low-pass filter or an infrared cut filter and has no refractive power. IP represents an image plane, where the imaging surface of an image sensor (photoelectric conversion element) such as a CCD sensor or CMOS sensor, or the film surface (photosensitive surface) of a silver film, is located.

The characteristics of the optical system OL according to each example will now be described.

An object-side lens of the first lens unit L1 is a negative lens (lens A). By placing the negative lens at a position closest to the object of the first lens unit L1, the optical system OL may have a wide angle and can effectively correct lateral chromatic aberration and distortion aberration. The negative lens disposed closest to the object of the first lens unit L1 may be a resin lens or a glass lens.

The second lens unit L2 includes one or more negative lenses (lens B). In at least one of one or more negative lenses of the second lens unit L2, let Ndn2 be a refractive index at the d-line and vdn2 be an Abbe number based on the d-line. The at least one negative lens may be a resin lens or a glass lens. Let f be a focal length of the optical system OL and SL be an air-equivalent distance from the aperture stop SP to the image plane IP on the optical axis. Then, at least one of the following inequalities (1), (2), or (3) may be satisfied:

$$1.7 \leq Ndn 2 \leq 2 \text{.00} \qquad ( 1 )$$

$$8. \leq ν dn 2 \leq 22. \qquad ( 2 )$$

$$0.8 \leq SL / f \leq 3. \qquad ( 3 )$$

Inequality (1) defines a proper range of a refractive index for the negative lens included in the second lens unit L2. In order to reduce the size of the optical system OL, particularly reducing its overall length, the positive refractive power of the entire optical system OL may be increased. Using high refractive index materials that satisfy inequality (1) for the negative lenses in the second lens unit L2 may reduce the overall length of the optical system OL and effectively correct the positive Petzval sum generated in the optical system OL. In a case where Ndn2 becomes lower than the lower limit of inequality (1), the curvature of the negative lens increases, and the shaping performance reduces due to the smaller thickness deviation ratio of the negative lens. In a case where Ndn2 becomes higher than the upper limit of inequality (1), the specific gravity of the negative lens material increases, and it becomes difficult to reduce the weight of the optical system.

The lower limit of inequality (1) may be set to 1.705 or 1.71, and the upper limit of inequality (1) may be set to 1.90, 1.86, or 1.76.

Inequality (2) defines a proper range of an Abbe number for the negative lens included in the second lens unit L2. In order to properly correct chromatic aberration in the second lens unit L2, positive lenses may be as low-dispersion as possible, while negative lenses may be as high-dispersion as possible. In a case where vdn2 becomes higher than the upper limit of inequality (2), it becomes difficult to effectively correct chromatic aberration. In a case where vdn2 becomes lower than the lower limit of inequality (2), the chromatic aberration correction may become excessive.

The lower limit of inequality (2) may be set to 10.0, 12.0, 14.0, or 16.0, and the upper limit of inequality (2) may be set to 21.0, 20.0, 19.0, or 18.0.

Using resin lenses for the negative lenses in the second lens unit L2 can achieve both the light weight of the optical system OL and effective aberration correction utilizing the aspherical shapes.

Inequality (3) defines a proper relationship between the focal length of the entire optical system OL and the air-equivalent distance SL from the aperture stop SP to the image plane IP, in order to achieve good optical performance while balancing wide-angle and reducing the overall length. In a case where SL/f becomes lower than the lower limit of inequality (3), it becomes difficult to achieve sufficient correction of curvature of field and chromatic aberration or good optical performance in the wide-angle optical system OL. On the other hand, in a case where SL/f becomes higher than the upper limit of inequality (3), the overall length increases and it becomes difficult to reduce the size of the optical system OL.

The lower limit of inequality (3) may be set to 0.9, 1.0, 1.1, 1.2, or 1.3, and the upper limit of inequality (3) may be set to 2.7, 2.5, 2.2, 2.0, or 1.7.

The first lens unit L1 may include at least one positive lens. For a cemented lens, the number of lenses is considered to be N in a case where N lenses are cemented together. Placing one or more positive lenses in the first lens unit L1 can reduce the diameter of the first lens unit L1 while achieving a wide-angle design and effectively correcting longitudinal chromatic aberration. The positive lenses included in the first lens unit L1 may be resin or glass lenses.

For at least one positive lens among one or more positive lenses included in the first lens unit L1, let Ndp1 be a refractive index at the d-line and vdp1 be an Abbe number based on the d-line. Then, the following inequalities (4) and (5) may be satisfied:

$$1.5 \leq Ndp 1 \leq 2.1 \qquad ( 4 )$$

$$22. \leq ν dp 1 \leq 45. \qquad ( 5 )$$

Inequalities (4) and (5) define proper ranges of a refractive index and an Abbe number for the positive lenses in the first lens unit L1. The refractive index and Abbe number of the positive lenses in the first lens unit L1 may be properly set within the range that satisfies inequalities (4) and (5), according to the refractive index, Abbe number, and arrangement of the negative lenses in the second lens unit L2.

In a case where Ndp1 becomes higher than the upper limit of inequality (4), manufacturing sensitivity to spherical aberration and longitudinal chromatic aberration becomes too large. In a case where Ndp1 becomes lower than the lower limit of inequality (4), the curvature of the positive lens may increase, and the size of the positive lens increases.

The lower limit of inequality (4) may be set to 1.52, 1.54, 1.56, or 1.58, and the upper limit of inequality (4) may be set to 2.00, 1.95, or 1.90.

In a case where vdp1 becomes higher than the upper limit of inequality (5), the correction of longitudinal chromatic aberration may become excessive. In a case where vdp1 becomes lower than the lower limit of inequality (5), the correction of longitudinal chromatic aberration may become insufficient.

The lower limit of inequality (5) may be set to 22.5 or 23.0, and the upper limit of inequality (5) may be set to 44.0 or 43.0.

Let d1 is a distance on the optical axis from the aperture stop SP to the object-side lens surface of the negative lens closest to the object among the one or more negative lenses in the second lens unit L2 in the optical system OL. Then, the following inequality (6) may be satisfied:

$$0.05 \leq d 1 / f \leq 0.30 \qquad ( 6 )$$

Inequality (6) defines a proper relationship between the focal length of the optical system OL and the distance from the aperture stop SP to the object-side lens surface of the negative lens closest to the object in the second lens unit L2, to effectively correct longitudinal chromatic aberration while achieving wide-angle and miniaturization of the optical system OL. In a case where d1/f becomes higher than the upper limit of inequality (6), it becomes difficult to effectively correct longitudinal chromatic aberration in the second lens unit L2. In a case where d1/f becomes lower than the lower limit of inequality (6), it becomes difficult to reduce the diameters of the lenses on the object side and the image side of the aperture stop and the size of the optical system OL increases.

The lower limit of inequality (6) may be set to 0.10, 0.15, or 0.20, and the upper limit of inequality (6) may be set to 0.29, 0.28, or 0.27.

In order to achieve wide-angle and size reduction of the optical system OL and effectively correct curvature of field and lateral chromatic aberration, the following inequality may be satisfied:

$$0.05 \leq d 2 / f \leq 0.50 \qquad ( 7 )$$

where d2 is a distance from the image-side lens surface of the negative lens closest to the image plane among one or more negative lenses included in the second lens unit L2 to the image plane IP.

Inequality (7) defines a proper relationship between the focal length of the entire optical system OL and the distance from the image-side lens surface of the negative lens closest to the image plane of the second lens unit L2 to the image plane IP. In a case where d2/f becomes higher than the upper limit of inequality (7), the overall length of the optical system OL increases. In a case where d2/f becomes lower than the lower limit of inequality (7), it becomes difficult to reduce the diameter of the lens disposed on the image side of the aperture stop SP, thus the size of the optical system OL increases, and it becomes difficult to place an optical filter etc.

The lower limit of inequality (7) may be set to 0.10, 0.15, or 0.20, and the upper limit of inequality (7) may be set to 0.45, 0.40, or 0.35.

The following inequality may be satisfied:

$$0.05 d 3 / f \leq 0.50 \qquad ( 8 )$$

where d3 is a distance d3 on the optical axis from the image-side lens surface of the positive lens in the first lens unit L1 that satisfies inequalities (4) and (5) to the aperture stop SP.

Inequality (8) defines a proper relationship between the focal length of the optical system OL and the distance from the image-side lens surface of the positive lens closest to the image plane of the first lens unit L1 to the aperture stop SP. In a case where d3/f becomes higher than the upper limit of inequality (8), longitudinal chromatic aberration may not be effectively corrected, the diameters of the lenses near the aperture stop SP may not be reduced, and thus the size of the optical system OL increases. In a case where d3/f becomes lower than the lower limit of inequality (8), the sensitivity to the distance between the positive lens in the first lens unit L1 and the aperture stop SP may become high.

The lower limit of inequality (8) may be set to 0.06 or 0.07, and the upper limit of inequality (8) may be set to 0.40, 0.30, 0.20, or 0.15.

The lenses adjacent to the aperture stop SP on both the object side and the image side (i.e., the most image-side lens of the first lens unit L1 and the most object-side lens of the second lens unit L2) may be positive lenses. Thereby, the size of the optical system OL can be reduced even if the optical system OL has a wide angle, and thereby the diameters of the lenses near the aperture stop SP can be reduced.

One or more negative lenses in the second lens unit L2 may have an aspherical shape with an inflection point. The inflection point refers to a point where, let x be a displacement amount from a surface vertex in the optical axis direction, h be a height from the optical axis in a radial direction perpendicular to the optical axis, and x(h) be an aspherical shape, the value of the second derivative obtained by differentiating x(h) twice with respect to h becomes zero, and the sign of the second derivative changes before and after that point. In other words, it refers to a point where the surface shape switches from concave to convex, or from convex to concave. Having an inflection point in the aspherical shape of the negative lens allows the refractive power of the peripheral portion of the negative lens to be determined independently of the refractive power of the paraxial portion, thereby facilitating correction of field curvature. Furthermore, the incident angle of light passing through the optical system OL on the imaging surface (image sensor) can be prevented from becoming too large.

The negative lens with the aspherical shape having an inflection point may be disposed on the image side of the aperture stop SP, and the negative lens closest to the image plane in the second lens unit L2 may have this aspherical shape. The position of the inflection point may be anywhere within the effective diameter of the lens surface, but it may be in the peripheral portion.

At least one of the first lens unit L1 and the second lens unit L2 may include a resin lens with an aspherical shape on either the object-side or image-side lens surface. Using a resin aspherical lens may increase the shape freedom in the lens surface design, and even with the reduced size and weight, a variety of aberrations such as curvature of field and distortion can be satisfactorily corrected.

Next, the optical systems OL for Examples 1 to 4 will be described in detail. Numerical examples corresponding to Examples 1 to 4 will be provided after Example 4.

In Example 1 (numerical example 1) and Example 3 (numerical example 3), the first lens unit L1 consists of a negative lens and a positive lens arranged in order from the object side to the image side. The negative lens has an aspherical shape with an inflection point on both the object-side and image-side lens surfaces. The positive lens satisfies inequalities (4) and (5), and both its object-side and image-side lens surfaces have aspherical shapes.

The second lens unit L2 consists of a positive lens, a negative lens, a positive lens, a positive lens, and a negative lens, arranged in order from the object side to the image side. The first and third positive lenses from the object side have aspherical shapes on both the object-side and image-side lens surfaces. The second negative lens from the object side satisfies inequalities (1) and (2), and its object-side and image-side lens surfaces are aspherical. The fourth positive lens and fifth negative lens (closest to the image plane) have aspherical surfaces with inflection points.

In the optical system OL according to Example 2 (numerical example 2), the first lens unit L1 consists of a negative lens and a positive lens arranged in order from the object side to the image side. The negative lens has an aspherical shape with an inflection point on both the object-side and image-side lens surfaces. The positive lens satisfies inequalities (4) and (5), and both its object-side and image-side lens surfaces are aspherical.

The second lens unit L2 consists of a positive lens, a negative lens, a positive lens, a positive lens, and a negative lens, arranged in order from the object side to the image side. The first and third positive lenses and the second negative lens from the object side have aspherical shapes on both the object-side and image-side lens surfaces. The fourth positive lens from the object side has an aspherical shape with an inflection point. The fifth negative lens from the object side satisfies inequalities (1) and (2) and has aspherical surfaces with an inflection point.

In the optical system OL according to Example 4 (numerical example 4), the first lens unit L1 consists of a negative lens, a negative lens, and a positive lens arranged in order from the object side to the image side. The two negative lenses have aspherical shapes with inflection points on both the object-side and image-side lens surfaces. The positive lens satisfies inequalities (4) and (5), and both its object-side and image-side lens surfaces are aspherical.

The second lens unit L2 consists of a positive lens, a negative lens, a positive lens, a positive lens, and a negative lens, arranged in order from the object side to the image side. The first and third positive lenses from the object side have aspherical shapes on both the object-side and image-side lens surfaces. The second negative lens from the object side satisfies inequalities (1) and (2), and its object-side and image-side lens surfaces are aspherical. The fourth positive lens and fifth negative lens from the object side have aspherical surfaces with inflection points.

Next, numerical examples 1 to 4 will be illustrated. In the surface data for each numerical example, a surface number i indicates the order of the surface counted from the object side. A radius r represents a radius of curvature (mm) of an i-th surface (paraxis for an aspherical surface), d represents a lens thickness or air gap (mm) between i-th and (i+1)-th surfaces on the optical axis, and nd represents a refractive index at the d-line of the optical material between i-th and (i+1)-th surfaces. The Abbe number vd based on the d-line is calculated as:

$$ν d = ( Nd - 1 ) / ( NF - NC )$$

where Nd, NF, and NC are refractive indices for the d-line (587.6 nm), F-line (486.1 nm), and C-line (656.3 nm) in the Fraunhofer line, respectively.

Each numerical example illustrates a focal length and half angle of view (°) at the d-line, and the maximum image height corresponding to the half angle of view as the image height. d, focal length, F-number, and half angle of view are values in the in-focus state at infinity. BF represents back focus (mm). The back focus is a distance on the optical axis from the lens surface closest to the image plane in the optical system (the final surface) to the paraxial image plane, expressed as an air-equivalent length. The overall lens length is a distance on the optical axis from the lens surface closest to the object in the optical system (the frontmost surface) to the final surface, plus the back focus.

An asterisk “*” next to a surface number indicates that the surface has an aspherical shape. The aspherical shape is expressed by the following equation:

$$X = \frac{{H}^{2} / R}{1 + \sqrt{1 - ( 1 + k ) {( H / R )}^{2}}} + A 4 \cdot {H}^{4} + A 6 \cdot {H}^{6} + A 8 \cdot {H}^{8} + A 10 \cdot {H}^{10} + A 12 \cdot {H}^{12} + A 14 \cdot {H}^{14} + A 16 \cdot {H}^{16}$$

where X is a displacement amount from a surface vertex in the optical axis direction, H is a height from the optical axis in a direction perpendicular to the optical axis, the light travel direction is positive, R is a paraxial radius of curvature, K is a conic constant, and A4, A6, A8, A10, A12, A14, and A16 are aspherical coefficients.

NUMERICAL EXAMPLE 1
UNIT: mm
SURFACE DATA

| Surface No. | r | d | nd | νd |
|---|---|---|---|---|
| 1* | −7.343 | 1.21 | 1.53504 | 55.7 |
| 2* | −17.116 | 1.29 | | |
| 3* | 4.129 | 0.78 | 1.61550 | 25.8 |
| 4* | 4.887 | 0.69 | | |
| 5 (SP) | ∞ | 0.19 | | |
| 6* | 7.660 | 1.13 | 1.53504 | 55.7 |
| 7* | −4.756 | 0.09 | | |
| 8* | −36.444 | 0.30 | 1.71000 | 17.5 |
| 9* | 13.036 | 1.10 | | |
| 10* | −141.694 | 0.76 | 1.53504 | 55.7 |
| 11* | 253.511 | 0.83 | | |
| 12* | 131.480 | 1.42 | 1.53504 | 55.7 |
| 13* | −3.051 | 0.35 | | |
| 14* | 4.682 | 0.99 | 1.56650 | 37.6 |
| 15* | 1.688 | 1.30 | | |
| 16 | ∞ | 0.50 | 1.51633 | 64.1 |
| 17 | ∞ | (Variable) | | |
| Image Plane | ∞ | | | |

### Aspheric Data

### 1st Surface

K=−1.98095e+01A4=5.24170e−03A6=−3.32409e−04A8=2.34005e−05A10=−1.25217e−06A12=5.05787e−08A14=−1.29642e−09A16=1.60236e−11

### 2nd Surface

K=2.35364e+00A4=1.30721e−02A6=−1.57044e−03A8=3.00113e−04A10=−4.62086e−05A12=4.96560e−06A14=−3.03043e−07A16=8.09993e−09

### 3rd Surface

K=−1.10083e+00A4=−1.07516e−03A6=−9.23201e−04A8=−2.61756e−05

### 4th Surface

K=−9.21866e+00A4=6.99546e−03A6=−2.55710e−03A8=3.25703e−04A10=−5.51418e−05A12=1.17027e−05A14=−2.08794e−06A16=2.15812e−07

### 6th Surface

K=−2.59631e+00A4=2.23124e−03A6=3.25218e−04A8=−1.04915e−04A10=−5.41856e−05A12=4.63220e−05A14=−1.30080e−05A16=1.46392e−06

### 7th Surface

K=−1.81981e+01A4=−6.69033e−03A6=−4.09184e−03A8=2.41801e−03A10=−6.15118e−04A12=6.45419e−05A14=3.07483e−07A16=−1.28007e−07

### 8th Surface

K=−1.00769e+02A4=4.64384e−03A6=−7.86878e−03A8=3.27938e−03A10=−8.12812e−04A12=1.17577e−04A14=−6.88831e−06A16=1.85055e−08

### 9th Surface

K=−1.69137e+02A4=4.05313e−03A6=−2.53098e−03A8=6.98932e−04A10=−7.74106e−05A12=−4.87907e−07A14=1.58697e−06A16=−1.30318e−07

### 10th Surface

K=1.00015e+02A4=−1.08992e−02A6=−5.07550e−04A8=4.81457e−04A10=−1.40206e−04A12=2.05603e−05A14=−1.57405e−06A16=5.61059e−08

### 11th Surface

K=6.78202e+03A4=−7.82956e−03A6=−2.34549e−03A8=3.85004e−04A10=1.56162e−05A12=−1.28849e−05A14=1.59644e−06A16=−6.43745e−08

### 12th Surface

K=−9.83382e+01A4=2.40959e−02A6=−5.09990e−03A8=6.80227e−04A10=−6.93759e−05A12=4.63366e−06A14=−1.73964e−07A16=2.72005e−09

### 13th Surface

K=−8.01482e+00A4=2.59170e−02A6=−2.84352e−03A8=1.12531e−04A10=8.59881e−07A12=−2.41292e−07A14=7.94402e−09A16=−8.55891e−11

### 14th Surface

K=−2.99357e+00A4=−7.16984e−03A6=−5.17986e−04A8=5.57212e−05A10=−1.23962e−06A12=−1.88030e−08A14=1.07717e−09A16=−1.14998e−11

### 15th Surface

K=−3.90760e+00A4=−5.04160e−03A6=1.34801e−04A8=8.88848e−07A10=−2.79912e−07A12=1.10408e−08A14=−1.80509e−10A16=1.05924e−12

| | |
|---|---|
| Focal Length | 6.34 |
| Fno | 1.85 |
| Half Angle of View (°) | 51.20 |
| Image Height | 7.89 |
| Overall Lens Length | 13.55 |
| BF | 0.62 |

NUMERICAL EXAMPLE 2
UNIT: mm
SURFACE DATA

| Surface No. | r | d | nd | νd |
|---|---|---|---|---|
| 1* | −4.873 | 0.96 | 1.53504 | 55.7 |
| 2* | −6.456 | 1.33 | | |
| 3* | 3.530 | 0.57 | 1.63910 | 23.5 |
| 4* | 3.522 | 0.70 | | |
| 5 (SP) | ∞ | 0.20 | | |
| 6* | 8.266 | 1.49 | 1.53504 | 55.7 |
| 7* | −4.110 | 0.06 | | |
| 8* | 61.252 | 0.43 | 1.67070 | 19.3 |
| 9* | 8.590 | 1.03 | | |
| 10* | −18.646 | 0.90 | 1.53504 | 55.7 |
| 11* | 365.289 | 0.67 | | |
| 12* | 26.553 | 1.48 | 1.53504 | 55.7 |
| 13* | −4.018 | 0.80 | | |
| 14* | 6.476 | 1.10 | 1.71000 | 17.5 |
| 15* | 2.441 | 1.05 | | |
| 16 | ∞ | 0.50 | 1.51633 | 64.1 |
| 17 | ∞ | (Variable) | | |
| Image Plane | ∞ | | | |

### Aspheric Data

### 1st Surface

K=−1.09913e+01A4=6.45976e−03A6=−4.04368e−04A8=2.61346e−05A10=−1.24348e−06A12=4.77907e−08A14=−1.23139e−09A16=1.71017e−11

### 2nd Surface

K=−1.75661e+01A4=1.18518e−02A6=−1.45448e−03A8=2.89808e−04A10=−4.58195e−05A12=4.92348e−06A14=−2.97034e−07A16=7.90019e−09

### 3rd Surface

K=−7.85528e−01A4=2.88552e−03A6=−1.52589e−03A8=−1.18788e−04

### 4th Surface

K=−2.92722e+00A4=9.20757e−03A6=−2.65910e−03A8=4.45068e−04A10=−1.95131e−04A12=1.45058e−05A14=5.90569e−06A16=−8.98610e−07

### 6th Surface

K=−1.88492e−01A4=3.54989e−03A6=−9.36345e−05A8=1.13936e−04A10=−3.56978e−05A12=1.02055e−05A14=−2.79131e−06A16=3.54854e−07

### 7th Surface

K=−1.46176e+01A4=−8.98332e−03A6=−2.53591e−03A8=1.96660e−03A10=−5.77951e−04A12=9.04138e−05A14=−7.11945e−06A16=2.76931e−07

### 8th Surface

K=−1.00310e+02A4=1.81623e−03A6=−6.86663e−03A8=2.71780e−03A10=−6.90662e−04A12=1.06031e−04A14=−9.12891e−06A16=3.75755e−07

### 9th Surface

K=−7.96907e+01A4=4.28756e−03A6=−2.84830e−03A8=6.44829e−04A10=−7.42327e−05A12=1.94447e−06A14=6.76264e−07A16=−5.60021e−08

### 10th Surface

K=2.36888e+01A4=−1.08156e−02A6=3.65648e−04A8=4.59507e−04A10=−1.55688e−04A12=2.17650e−05A14=−1.11625e−06A16=7.40975e−09

### 11th Surface

K=1.27607e+04A4=−7.77514e−03A6=−1.87299e−03A8=2.51766e−04A10=3.55703e−05A12=−1.31412e−05A14=1.37176e−06A16=−4.83232e−08

### 12th Surface

K=−3.65777e+01A4=2.19035e−02A6=−4.89659e−03A8=6.83099e−04A10=−7.07238e−05A12=4.66440e−06A14=−1.72510e−07A16=2.69190e−09

### 13th Surface

K=−5.82185e+00A4=2.60835e−02A6=−2.69747e−03A8=9.86394e−05A10=9.76691e−07A12=−2.11496e−07A14=6.55654e−09A16=−6.70240e−11

### 14th Surface

K=−9.64077e−01A4=−4.49795e−03A6=−6.13289e−04A8=4.85003e−05A10=−1.18469e−06A12=−1.02361e−08A14=1.15533e−09A16=−1.83206e−11

### 15th Surface

K=−4.30441e+00A4=−3.99838e−03A6=8.54821e−05A8=1.61338e−06A10=−2.84375e−07A12=1.10383e−08A14=−1.79692e−10A16=1.05699e−12

| | |
|---|---|
| Focal Length | 6.34 |
| Fno | 1.85 |
| Half Angle of View (°) | 51.22 |
| Image Height | 7.89 |
| Overall Lens Length | 13.55 |
| BF | 0.28 |

NUMERICAL EXAMPLE 3
UNIT: mm
SURFACE DATA

| Surface No. | r | d | nd | νd |
|---|---|---|---|---|
| 1* | −6.431 | 1.05 | 1.53504 | 55.7 |
| 2* | −8.234 | 0.77 | | |
| 3* | 3.655 | 0.65 | 1.85135 | 40.1 |
| 4* | 4.234 | 0.54 | | |
| 5 (SP) | ∞ | 0.33 | | |
| 6* | 10.536 | 1.29 | 1.53504 | 55.7 |
| 7* | −6.299 | 0.04 | | |
| 8* | −15.992 | 0.48 | 1.73500 | 16.5 |
| 9* | 42.490 | 1.05 | | |
| 10* | 38.554 | 0.59 | 1.53504 | 55.7 |
| 11* | 74.796 | 0.80 | | |
| 12* | 2391.113 | 1.21 | 1.53504 | 55.7 |
| 13* | −3.604 | 0.64 | | |
| 14* | 5.170 | 0.92 | 1.56650 | 37.6 |
| 15* | 1.906 | 1.20 | | |
| 16 | ∞ | 0.50 | 1.51633 | 64.1 |
| 17 | ∞ | (Variable) | | |
| Image Plane | ∞ | | | |

### Aspheric Data

### 1 st Surface

K=−1.30125e+01A4=4.82126e−03A6=−3.31519e−04A8=2.50370e−05A10=−1.26076e−06A12=3.61786e−08A14=−3.68282e−10A16=−3.15263e−12

### 2nd Surface

K=−8.08691e+00A4=1.30984e−02A6=−1.93253e−03A8=3.41047e−04A10=−4.39441e−05A12=3.92885e−06A14=−2.06697e−07A16=4.98571e−09

### 3rd Surface

K=−6.61549e−01A4=5.57432e−03A6=−4.58729e−04A8=1.79978e−04

### 4th Surface

K=−2.95424e+00A4=7.27798e−03A6=7.56586e−04A8=−7.21951e−04A10=7.04669e−04A12=−2.89159e−04A14=6.12405e−05A16=−5.22252e−06

### 6th Surface

K=−7.58785e+00A4=2.22825e−03A6=−1.87832e−04A8=4.81733e−04A10=−4.45157e−04A12=2.03367e−04A14=−4.70785e−05A16=4.13873e−06

### 7th Surface

K=−4.86024e+01A4=−9.97097e−03A6=−4.32498e−03A8=2.91883e−03A10=−5.69292e−04A12=−3.54974e−05A14=2.59487e−05A16=−2.61737e−06

### 8th Surface

K=3.10606e+01A4=6.01476e−03A6=−1.03304e−02A8=4.58759e−03A10=−9.89021e−04A12=7.91015e−05A14=5.63237e−06A16=−9.87792e−07

### 9th Surface

K=−3.17185e+03A4=9.00285e−04A6=−2.23444e−03A8=6.61418e−04A10=−7.11829e−05A12=−3.94820e−06A14=1.83440e−06A16=−1.17101e−07

### 10th Surface

K=−5.07244e+01A4=−9.64028e−03A6=−6.90179e−04A8=5.38425e−04A10=−1.42950e−04A12=1.92972e−05A14=−1.44668e−06A16=5.00364e−08

### 11th Surface

K=5.40178e+02A4=−7.06524e−03A6=−2.13477e−03A8=3.09406e−04A10=2.76773e−05A12=−1.28022e−05A14=1.36009e−06A16=−4.82855e−08

### 12th Surface

K=5.00036e+01A4=2.79723e−02A6=−5.73047e−03A8=7.64138e−04A10=−7.62354e−05A12=4.86812e−06A14=−1.71990e−07A16=2.50260e−09

### 13th Surface

K=−9.14035e+00A4=2.96800e−02A6=−3.30693e−03A8=1.50129e−04A10=−1.64736e−06A12=−1.20227e−07A14=4.61998e−09A16=−4.90715e−11

### 14th Surface

K=−5.92288e−01A4=−7.99776e−03A6=−5.51923e−04A8=5.51163e−05A10=−1.19098e−06A12=−1.74822e−08A14=9.64561e−10A16=−9.73722e−12

### 15th Surface

K=−3.75926e+00A4=−5.42761e−03A6=2.75476e−04A8=−9.77415e−06A10=−1.45966e−08A12=1.11867e−08A14=−2.75151e−10A16=2.05414e−12

| | |
|---|---|
| Focal Length | 6.55 |
| Fno | 1.85 |
| Half Angle of View (°) | 50.29 |
| Image Height | 7.89 |
| Overall Lens Length | 12.24 |
| BF | 0.17 |

NUMERICAL EXAMPLE 4
UNIT: mm
SURFACE DATA

| Surface No. | r | d | nd | νd |
|---|---|---|---|---|
| 1* | −29.901 | 0.33 | 1.49710 | 81.6 |
| 2* | 18.742 | 0.58 | | |
| 3* | −8.114 | 0.62 | 1.53504 | 55.7 |
| 4* | −7.663 | 0.44 | | |
| 5* | 2.790 | 0.49 | 1.79099 | 42.2 |
| 6* | 3.142 | 0.59 | | |
| 7 (SP) | ∞ | 0.42 | | |
| 8* | 7.716 | 1.07 | 1.53504 | 55.7 |
| 9* | −4.430 | 0.01 | | |
| 10* | −17.062 | 0.55 | 1.71000 | 17.5 |
| 11* | 18.483 | 1.09 | | |
| 12* | 16.643 | 0.55 | 1.56650 | 37.6 |
| 13* | 8.611 | 0.78 | | |
| 14* | −21.401 | 0.92 | 1.53504 | 55.7 |
| 15* | −3.317 | 0.29 | | |
| 16* | 3.660 | 1.02 | 1.53504 | 55.7 |
| 17* | 1.858 | 1.20 | | |
| 18 | ∞ | 0.50 | 1.51633 | 64.1 |
| 19 | ∞ | (Variable) | | |
| Image Plane | ∞ | | | |

### Aspheric Data

### 1 st Surface

K=0.00000e+00A4=4.37293e−03A6=−2.44908e−04A8=3.41978e−05A10=−3.36025e−06A12=2.12092e−07A14=−6.89381e−09A16=1.03916e−10

### 2nd Surface

K=0.00000e+00A4=1.24510e−03A6=−1.44306e−05A8=1.28768e−04A10=−2.16234e−05A12=2.58480e−06A14=−2.13737e−07A16=8.40303e−09

### 3rd Surface

K=−2.81395e+01A4=8.91933e−03A6=2.74153e−04A8=2.58786e−05A10=−4.42776e−06A12=5.51441e−07A14=−5.66119e−08A16=4.01910e−09

### 4th Surface

K=−3.67561e+01A4=1.41768e−02A6=−7.19491e−05A8=1.99384e−04A10=−3.37890e−05A12=2.75366e−06A14=3.95789e−08A16=1.00667e−08

### 5th Surface

K=−2.86474e+00A4=1.04937e−02A6=−1.51427e−04A8=−7.80186e−04A10=4.71610e−04A12=−1.60485e−04A14=2.56547e−05A16=−2.05029e−06

### 6th Surface

K=−1.16226e+01A4=3.64030e−02A6=−1.75279e−02A8=8.61820e−03A10=−3.20568e−03A12=7.74028e−04A14=−1.15635e−04A16=7.41249e−06

### 8th Surface

K=−1.62704e+01A4=7.30129e−03A6=−1.30689e−03A8=7.59401e−04A10=−1.80720e−04A12=−1.65242e−05A14=1.99744e−05A16=−3.07023e−06

### 9th Surface

K=−1.96870e+01A4=−1.33514e−02A6=−1.83811e−03A8=1.28560e−03A10=1.69154e−04A12=−2.56419e−04A14=7.26814e−05A16=−7.19733e−06

### 10th Surface

K=−5.13674e+01A4=5.69860e−03A6=−8.18915e−03A8=3.56485e−03A10=−8.41558e−04A12=9.18101e−05A14=1.47209e−06A16=−1.06223e−06

### 11th Surface

K=−4.97484e+02A4=4.51697e−03A6=−1.46730e−03A8=2.73325e−04A10=−6.72772e−06A12=−2.03574e−06A14=1.70255e−08A16=3.36801e−08

### 12th Surface

K=−5.51463e+01A4=−2.64061e−02A6=3.60882e−03A8=−5.15396e−04A10=3.28231e−05A12=−7.08961e−06A14=1.44277e−06A16=−1.04249e−07

### 13th Surface

K=5.06176e+00A4=−2.45529e−02A6=1.13021e−03A8=−3.82289e−05A10=2.00748e−05A12=−8.55087e−06A14=1.21089e−06A16=−5.54231e−08

### 14th Surface

K=−5.16257e+01A4=3.39081e−02A6=−6.94596e−03A8=9.13852e−04A10=−8.83147e−05A12=5.40877e−06A14=−1.82710e−07A16=2.57171e−09

### 15th Surface

K=−8.93868e+00A4=2.99916e−02A6=−3.43881e−03A8=1.56305e−04A10=−2.05530e−06A12=−9.20159e−08A14=3.65353e−09A16=−3.46492e−11

### 16th Surface

K=−6.63060e−01A4=−1.34606e−02A6=−1.95754e−04A8=4.31335e−05A10=−1.10651e−06A12=−1.38456e−08A14=9.18198e−10A16=−1.02719e−11

### 17th Surface

K=−4.10910e+00A4=−4.07804e−03A6=−2.43934e−05A8=8.65651e−06A10=−4.12882e−07A12=9.37509e−09A14=−9.97394e−11A16=3.45100e−13

| | |
|---|---|
| Focal Length | 6.33 |
| Fno | 1.80 |
| Half Angle of View (°) | 51.27 |
| Image Height | 7.89 |
| Overall Lens Length | 12.02 |
| BF | 0.58 |

Table 1 summarizes the values of inequalities (1) to (8) for each numerical example. Numerical examples 1, 3, and 4 satisfy inequalities (1) to (6) and (8). Numerical example 2 satisfies inequalities (1) to (5), (7), and (8).

TABLE 1

Numerical Example

| | 1 | 2 | 3 | 4 |
|---|---|---|---|---|
| (1) 1.70 ≤ Ndn2 ≤ 2.00 | 1.71 | 1.71 | 1.74 | 1.71 |
| (2) 8.0 ≤ νdn2 ≤ 22.0 | 17.50 | 17.50 | 16.50 | 17.50 |
| (3) 0.8 ≤ SL/f ≤ 3.0 | 1.51 | 1.58 | 1.41 | 1.42 |
| (4) 1.50 ≤ Ndn1 ≤ 2.10 | 1.62 | 1.64 | 1.85 | 1.79 |
| (5) 22.0 ≤ νdp1 ≤ 45.0 | 25.80 | 23.50 | 40.10 | 42.24 |
| (6) 0.05 ≤ d1/f ≤ 0.3 | 0.22 | 1.11 | 0.25 | 0.24 |
| (7) 0.05 ≤ d2/f ≤ 0.50 | 1.24 | 0.29 | 1.08 | 1.10 |
| (8) 0.05 ≤ d3/f ≤ 0.50 | 0.11 | 0.11 | 0.08 | 0.09 |

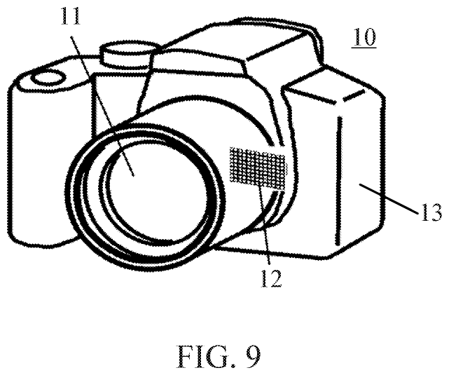

FIGS. 2, 4, 6, and 8 illustrate the longitudinal aberrations (spherical aberration, astigmatism, distortion, and chromatic aberration) of the optical systems OL according to numerical examples 1 to 4 in the in-focus state at infinity. In the spherical aberration diagram, Fno represents an F-number. A solid line indicates a spherical aberration amount for the d-line (wavelength 587.6 nm), and an alternate long and two short dashes line indicates a spherical aberration amount for the g-line (wavelength 435.8 nm). In the astigmatism diagram, a solid line ΔS represents an astigmatism amount on a sagittal image plane, and a broken line ΔM represents an astigmatism amount on a meridional image plane. The distortion diagram illustrates a distortion amount for the d-line. The chromatic aberration diagram illustrates a lateral chromatic aberration amount for the g-line. ω represents the half-angle (°).

### Image Pickup Apparatus

FIG. 9 illustrates a digital still camera 10 as an image pickup apparatus using any one of the optical systems according to Example 1 to 4 as the imaging optical system. Reference numeral 13 denotes a camera body, and reference numeral 11 denotes an imaging optical system that includes any one of the optical systems according to Example 1 to 4. Reference numeral 12 denotes an image sensor, such as a CCD sensor or a CMOS sensor, that is built into the camera body 13 and converts an object image formed by the imaging optical system 11 into an electrical signal (i.e., capturing an object via the optical system).

The image pickup apparatus is not limited to a digital still camera; it may also be a digital video camera, a film camera, a smartphone camera, a surveillance camera, or an on-board (in-vehicle) camera. The imaging optical system may be an interchangeable type that is attachable to and detachable from the camera body or may be of an integrated type. The camera body may also include or exclude a quick-return mirror.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each example can provide an optical system that has a reduced size and weight and good optical performance.

This application claims the benefit of Japanese Patent Application No. 2025-051313, filed on Mar. 26, 2025, which is hereby incorporated by reference herein in its entirety.

What is claimed is:

1. An optical system comprising, in order from an object side to an image side:
a first lens unit;
an aperture stop; and
a second lens unit,
wherein the first lens unit includes a lens A, which is closest to the object side and has a negative refractive power,
wherein the second lens unit includes a lens B having negative refractive power, and
wherein the following inequalities are satisfied:
$$1.7 \leq Ndn 2 \leq 2 \text{.00}$$
$$8. \leq vdn 2 \leq 22. , and$$
$$0.8 \leq SL / f \leq 3.$$
where Ndn2 is a refractive index of the lens B at d-line, vdn2 is an Abbe number of the lens B based on the d-line, f is a focal length of the optical system, and SL is an air-equivalent distance on an optical axis from the aperture stop to an image plane.

2. The optical system according to claim 1, wherein the lens B is made of a resin material.

3. The optical system according to claim 1, wherein the first lens unit includes a positive lens whose refractive index Ndp1 at the d-line and Abbe number vdp1 based on the d-line satisfy the following inequalities:
$$1.5 \leq Ndn 1 \leq 2.1$$
$$22. \leq vdp 1 \leq 45. .$$

4. The optical system according to claim 1, wherein the following inequality is satisfied:
$$0.05 \leq d 1 / f \leq 0.30$$
where d1 is a distance on an optical axis from the aperture stop to an object-side lens surface of the lens B.

5. The optical system according to claim 1, wherein the following inequality is satisfied:
$$0.05 \leq d 2 / f \leq 0.50$$
where d2 is a distance on an optical axis from an image-side lens surface of the lens B to the image plane.

6. The optical system according to claim 3, wherein the following inequality is satisfied:
$$0.05 \leq d 3 / f \leq 0.50$$
where d3 is a distance on an optical axis between an image-side lens surface of the positive lens in the first lens unit and the aperture stop SP.

7. The optical system according to claim 1, wherein both a lens closest to the image plane in the first lens unit and a lens closest to an object in the second lens unit have positive refractive power.

8. The optical system according to claim 1, wherein the second lens unit includes a lens having an aspherical lens surface with an inflection point.

9. The optical system according to claim 1, wherein at least one of the first lens unit and the second lens unit includes a resin lens having an aspherical lens surface on at least one of object-side and image-side surfaces.

10. The optical system according to claim 1, wherein the first lens unit includes the lens A and a positive lens disposed closer to the image plane than the lens A, and
wherein the second lens unit includes, in order from the object side to the image side, a positive lens, the lens B, a positive lens, a positive lens, and a negative lens.

11. An image pickup apparatus comprising:
an optical system; and
an image sensor configured to capture an object image via the optical system,
wherein the optical system includes, in order from an object side to an image side:
a first lens unit;
an aperture stop; and
a second lens unit,
wherein the first lens unit includes a lens A, which is closest to the object side and has a negative refractive power,
wherein the second lens unit includes a lens B having negative refractive power, and
wherein the following inequalities are satisfied:
$$1.7 \leq Ndn 2 \leq 2 \text{.00}$$
$$8. \leq vdn 2 \leq 22. , and$$
$$0.8 \leq SL / f \leq 3.$$
where Ndn2 is a refractive index of the lens B at d-line, vdn2 is an Abbe number of the lens B based on the d-line, f is a focal length of the optical system, and SL is an air-equivalent distance on an optical axis from the aperture stop to an image plane.
